(19) United States
(12) Patent Application Publication
(10) Pub. No.: US 2010/0100855 A1
(43) Pub. Date: Apr. 22, 2010

(54) HANDHELD TERMINAL AND METHOD FOR CONTROLLING THE HANDHELD TERMINAL USING TOUCH INPUT

(75) Inventor: Jioh YOO, Suwon-si (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/575,246

(22) Filed: Oct. 7, 2009

(30) Foreign Application Priority Data
Oct. 16, 2008 (KR) 10-2008-0101539

(51) Int. Cl. G06F 3/03; G06F 3/041; G06F 3/048

(52) U.S. Cl. 715/863; 345/173; 715/846

(57) ABSTRACT

A handheld terminal includes a coordinate recognizer to recognize a first coordinate on a screen where a touch starts and to recognize a second coordinate on the screen where the touch ends, a function identifier to identify a function corresponding to the pair of coordinates, and a function performer to perform the identified function. The first and second coordinates may respectively correspond to a service icon displayed at or near the first coordinate and a process area displayed at or near the second coordinate and associated with the identified function. A method for controlling a handheld terminal includes recognizing a first coordinate on a screen where a touch starts and a second coordinate on the screen where the touch ends, identifying a function corresponding to the first coordinate and the second coordinate, and performing the identified function.

### CROSS-REFERENCE TO RELATED APPLICATION

This application claims priority from and the benefit of Korean Patent Application No. 10-2008-0101539, filed on Oct. 16, 2008, which is hereby incorporated by reference for all purposes as if fully set forth herein.

### BACKGROUND OF THE INVENTION

1. Field of the Invention

The present invention relates to a handheld terminal using an touch input and a method for controlling a handheld terminal by identifying a function corresponding to a pair of coordinates of a touch input and performing the function.

2. Discussion of the Background

Recently, a touch screen capable of receiving a user input has been incorporated into handheld terminals as a display device. The handheld terminals having the touch screen may have a larger liquid crystal display (LCD) screen than a conventional handheld terminal.

However, handheld terminals may be carried in a pocket or a bag, and thus, an undesired input may cause the handheld terminal to perform an undesired function.

Hereinafter, as an example, a mobile communication terminal among handheld terminals will be described with reference to FIG. 1.

FIG. 1 illustrates an example of inputting a touch in a conventional mobile communication terminal.

As illustrated in a mobile communication terminal 110, when there is a call from a counterpart terminal, the mobile communication terminal 110 displays functions of ‘connect’, ‘wait’, and ‘reject’, and permits the functions of ‘connect’, ‘wait’, and ‘reject’ to be selected by the user according to an inputted touch in an area corresponding to the desired function.

Also, when a message is received as illustrated in a mobile communication terminal 120, the mobile communication terminal 120 displays functions of ‘display’ and ‘end’, and displays the message if the user touches the function of ‘display’ or switches to a different screen if the user touches the function of ‘end’.

Also, when the user selects a menu as illustrated in a mobile communication terminal 130, the mobile communication terminal 130 displays menu icons and provides a menu corresponding to a touched menu icon if the user touches one of the displayed menu icons.

That is, the user may touch a displayed icon once or more to select a corresponding function. Since the method is simply based on a touch, it is intuitive and simple. However, it also may increase the chance of receiving an unintentional touch and performing an unintended function. To prevent an unintended function from being performed, the mobile communication terminal may include a hold key or a method for activating and/or disabling a user interface (UI).

If a hold key is included, instances of performing of an unintended function may be reduced. However, releasing the hold key and setting the hold may be burdensome to a user. Similarly, a method for activating and/or disabling the UI may require the user to take additional steps before the user can select a function.

### SUMMARY OF THE INVENTION

Exemplary embodiments of the present invention provide a handheld terminal using an touch input to recognize a first coordinate where a touch starts and a second coordinate where the touch ends, to identify a function corresponding to the pair of coordinates, and to perform the identified function. Exemplary embodiments of the present invention also provide a method for controlling the handheld terminal as such.

Exemplary embodiments of the present invention also provide a handheld terminal using a touch input to identify and perform a function corresponding to a pair of coordinates including a first coordinate and a second coordinate. If a user drags a service icon from the first coordinate to the second coordinate in a process area and then drops the service icon, the function may be performed based on the drag-and-drop scheme. Exemplary embodiments of the present invention also provide a method for controlling the handheld terminal as such.

Additional features of the invention will be set forth in the description which follows, and in part will be apparent from the description, or may be learned by practice of the invention.

An exemplary embodiment of the present invention discloses a handheld terminal including a touch screen to receive a touch and to display a service icon, a first process area, and a second process area, the first process area corresponding to a first function associated with the service icon and the second process area corresponding to a second function associated with the service icon, a coordinate recognizer to recognize a first coordinate where the touch starts and to recognize a second coordinate where the touch ends, a function identifier to identify the first function or the second function as an identified function corresponding to a pair of coordinates comprising the first coordinate and the second coordinate, and a function performer to perform the identified function.

An exemplary embodiment of the present invention discloses a method for controlling a handheld terminal, including displaying a service icon, a first process area, and a second process area, the first process area corresponding to a first function associated with the service icon and the second process area corresponding to a second function associated with the service icon, receiving a touch on a touch screen, recognizing a first coordinate where the touch starts and a second coordinate where the touch ends, identifying the first function or the second function as an identified function corresponding to a pair of coordinates comprising the first coordinate and the second coordinate, and performing the identified function.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an example of providing a touch input in a convention mobile communication terminal.

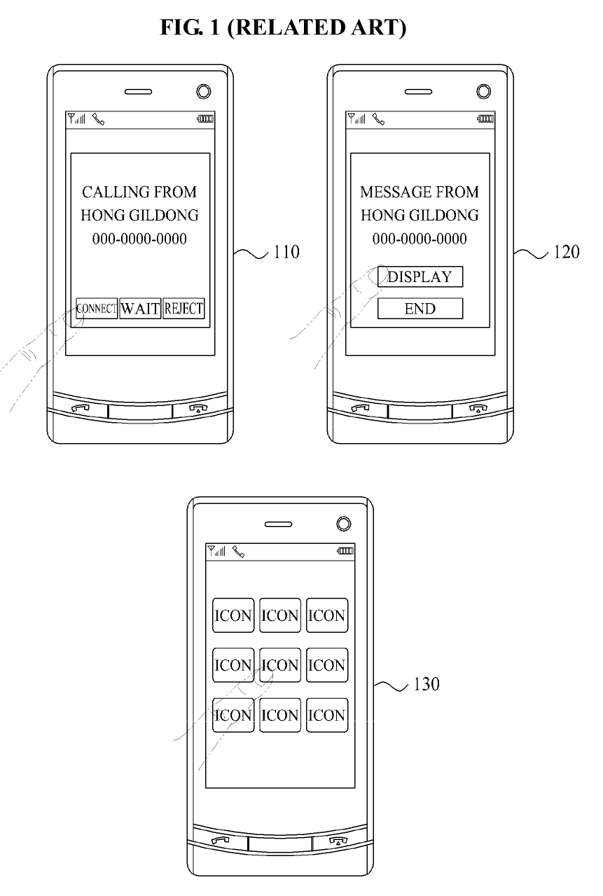

FIG. 2 illustrates a configuration of a handheld terminal according to an exemplary embodiment of the present invention.

FIG. 3 illustrates an example of performing a function according to a touch input in a handheld terminal according to an exemplary embodiment of the present invention.

FIG. 4 illustrates an example of performing a function according to a touch input in a handheld terminal according to an exemplary embodiment of the present invention.

FIG. 5 illustrates an example of performing a function according to a touch input in a handheld terminal according to an exemplary embodiment of the present invention.

FIG. 6 is a flowchart illustrating a method for controlling a handheld terminal using a touch input according to an exemplary embodiment of the present invention.

FIG. 7 is a flowchart illustrating a method for controlling a handheld terminal using a touch input according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. If an element is referred to as being “connected to” another element, it can be directly connected to the other element, or intervening elements may be present.

A handheld terminal according to the exemplary embodiments of the present invention may generally refer to any such device having mobility, such as a personal digital assistant (PDA), a portable multimedia player (PMP), an MP3 player, and the like, in addition to a notebook computer, a cellular phone, a personal communication service (PCS) phone, and a satellite/terrestrial wave digital multimedia broadcasting (DMB) phone.

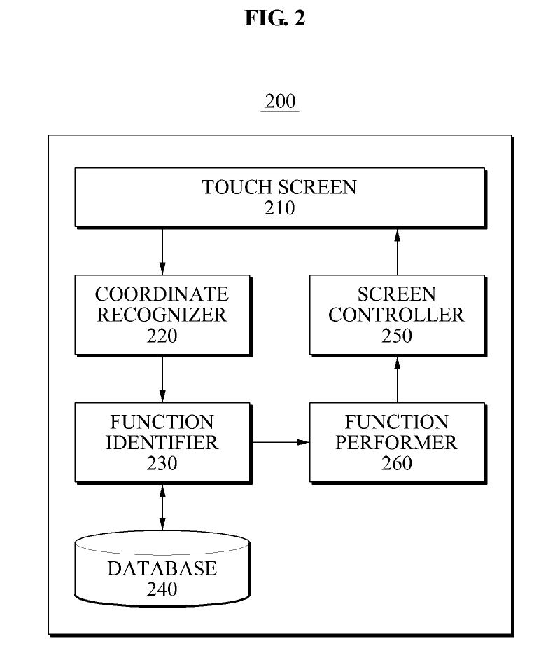

FIG. 2 illustrates a configuration of a handheld terminal 200 according to an exemplary embodiment of the present invention.

Referring to FIG. 2, a handheld terminal 200 may include a touch screen 210, a coordinate recognizer 220, a function identifier 230, a database 240, a screen controller 250, and a function performer 260.

The touch screen 210 is arranged in a display area of the handheld terminal 200, and receives a touch inputted by a user. The touch screen 210 is a screen containing an input device capable of receiving an input if a user touches a location or a character that is displayed on the screen with a user's hand or an object, in conjunction with or without using a keypad or other input devices.

The coordinate recognizer 220 recognizes a first coordinate on the touch screen 210 where a touch starts, and also recognizes a second coordinate on the touch screen 210 where the touch ends.

As an example, the coordinate recognizer 220 may divide the touch screen 210 into lattice girds, allocate a coordinate to each lattice grid, and thus, may recognize the first coordinate where a touch starts and the second coordinate where the touch ends, corresponding to the allocated coordinates. If the touch screen 210 is divided into twenty-four lattice grids, twenty-four coordinates may be generated. Also, the coordinate recognizer 220 may recognize a coordinate of a lattice grid where the user starts touching as the first coordinate and may recognize a coordinate of a lattice grid where the user finishes touching as the second coordinate. In this instance, the user may touch the touch screen 210 in a drag-and-drop scheme using the user's hand or the object. That is, the user may start a touch at the first coordinate, may drag the touch, i.e. maintain continuous contact with the touch screen 210, to the second coordinate, and may end the touch at the second coordinate to drop at the second coordinate.

The function identifier 230 may identify a function corresponding to a pair of coordinates, the pair of coordinates including the first coordinate and the second coordinate.

As an example, the function identifier 230 may identify the function corresponding to the pair of coordinates from the database 240.

The database 240 may store functions corresponding to pairs of coordinates. The pair of coordinates may be organized by a coordinate in a start coordinate area and a coordinate in an end coordinate area. That is, the start coordinate area and the end coordinate area each include at least one coordinate, and the pair of coordinates may be constructed by matching coordinates respectively from the start coordinate area and the end coordinate area. Further, the database 240 may include other categories to identify the functions, such as service icon as explained in more detail below, since a single pair of coordinates may correspond to more than one function. In this instance, the identification of the function associated with that single pair of coordinates may depend upon which service icon is displayed on the touch screen 210 at the time the touch begins and/or ends.

Hereinafter, description of performing a function will be made with reference to

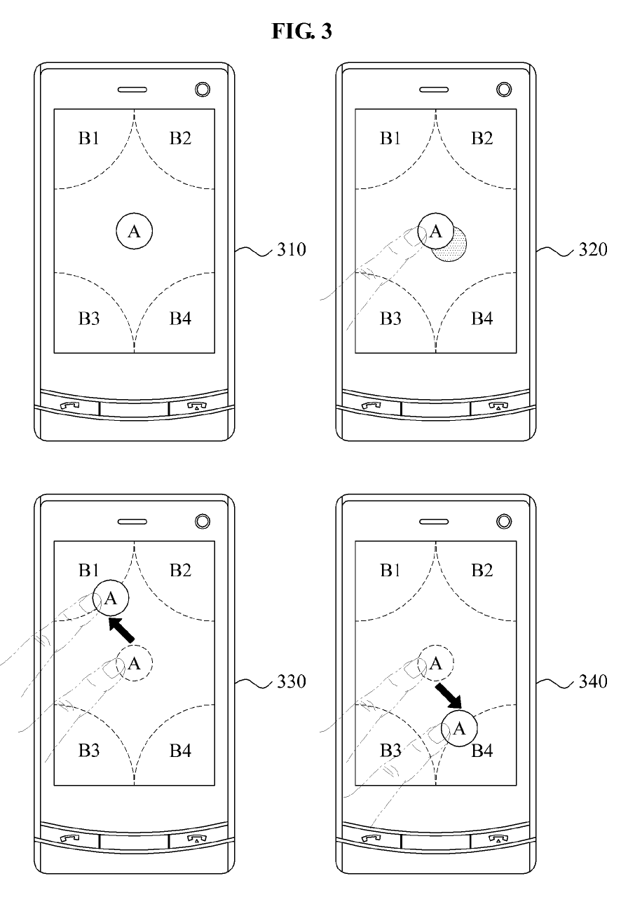

FIG. 3.

FIG. 3 illustrates an example of performing a function according to a touch input in a handheld terminal according to an exemplary embodiment of the present invention.

As illustrated in a handheld terminal 310, an A area is a start coordinate area or may be within a start coordinate area if the start coordinate area is larger than A area. A B1 area, a B2 area, a B3 area, and a B4 area each correspond to an end coordinate area, that is, a process area. Also, the handheld terminal 200 may match coordinates of the A area and coordinates of the B1 area, the B2 area, the B3 area, and the B4 area to construct pairs of coordinates that are stored in the database 240. As an example, a service icon for a call, such as a telephone receiver figure, may be displayed in the A area, and functions of ‘call connecting’, ‘call waiting’, ‘call ending’, and ‘call rejecting’ may be respectively allocated to and displayed in the B1 area, the B2 area, the B3 area, and the B4 area.

The database 240 constructs a pair of coordinates respectively included in the A area and the B1 area, matches this pair of coordinates with the function of ‘call connecting’, and stores the same. Also, in the same manner, the database 240 matches a constructed pair of coordinates including the A area and the B2 area with the function of ‘call waiting’ and stores the same, matches a constructed pair of coordinates including the A area and the B3 area with the function of ‘call ending’ and stores the same, and matches a constructed pair of coordinates including the A area and the B4 area with the function of ‘call rejecting’ and stores the same. As described above, the database 240 may also match these pairs of coordinates with the service icon of the telephone receiver figure.

The function performer 260 may perform the identified function.

The screen controller 250 may control to display the function that is currently performed in the touch screen 210, if the function is performed by the function performer 260.

Additionally, the coordinate recognizer 220 may recognize the first coordinate within the start coordinate area including the displayed service icon, even if the start coordinate area is larger than the displayed service icon. For example, the first coordinate may be related to the service icon displayed in the touch screen 210. If the user touches the first coordinate in the start coordinate area, but does not exactly touch the service icon, the coordinate recognizer 220 may still recognize the touch as a touch on the service icon.

As another example, the second coordinate may be related to a process area that is allocated to the touch screen 210 according to a function. In this instance, the coordinate recognizer 220 may recognize the second coordinate in a single process area from among many different process areas, each allocated to a different function.

A size of the process area allocated on the touch screen 210 may be adjustable according to a frequency of use of the corresponding function. The adjustment of size may be according to a user setting, or the screen controller 250 may recognize a frequency of use and increase a size of the process area as frequency of use increases, up to a limit. The limit may depend upon the number of process areas displayed at a single time and associated with a single service icon. As illustrated in FIG. 3, there may be more than one process area displayed on the touch screen 210 at a given time, and the second coordinate may be recognized in a single process area.

As illustrated in a handheld terminal 320, if a user touches the A area, the coordinate recognizer 220 recognizes the first coordinate from the A area where the touch starts. The user may drag the touch, i.e. maintain continuous contact with the touch screen 210, to a second coordinate, that is, the B1 area, the B2 area, the B3 area, or the B4 area.

As illustrated in a handheld terminal 330, the user may touch the A area, and then may drag and drop the touch to the B1 area. In this instance, the coordinate recognizer 220 recognizes the first coordinate in the A area and the second coordinate in the B1 area. Accordingly, the function identifier 230 may identify a function, such as ‘call connecting’, and the function performer 260 may control the handheld terminal 330 to connect a call with a counterpart.

As illustrated in a handheld terminal 340, the user may touch the A area and then may drag and drop to the B4 area. Here, the coordinate recognizer 220 recognizes the first coordinate in the A area and recognizes the second coordinate in the B4 area. Accordingly, the function identifier 230 may identify a function, such as ‘call rejecting’, and the function performer 260 may control the handheld terminal 340 to reject the call.

The screen controller 250 may display a service icon of the A area, and process areas of the B1 area, the B2 area, the B3 area, and the B4 area in the touch screen 210. Accordingly, the user may move the service icon of the A area to a process area where a desired function among the displayed process areas are shown to perform the intended function.

The handheld terminal 200 may adjust a size of the start coordinate area where the first coordinate is recognized on the touch screen 210 and the size of the process area where the second coordinate is recognized on the touch screen 210. That is, the handheld terminal 200 may increase the size of the start coordinate area and the size of the process area, and also may minimize the size of the start coordinate area and the size of the process area. Also, the handheld terminal 200 may dynamically adjust the size of the start coordinate area and the process area, whereby one area is increased in size while another is maintained or decreased in size, thereby more appropriately harmonizing the sizes.

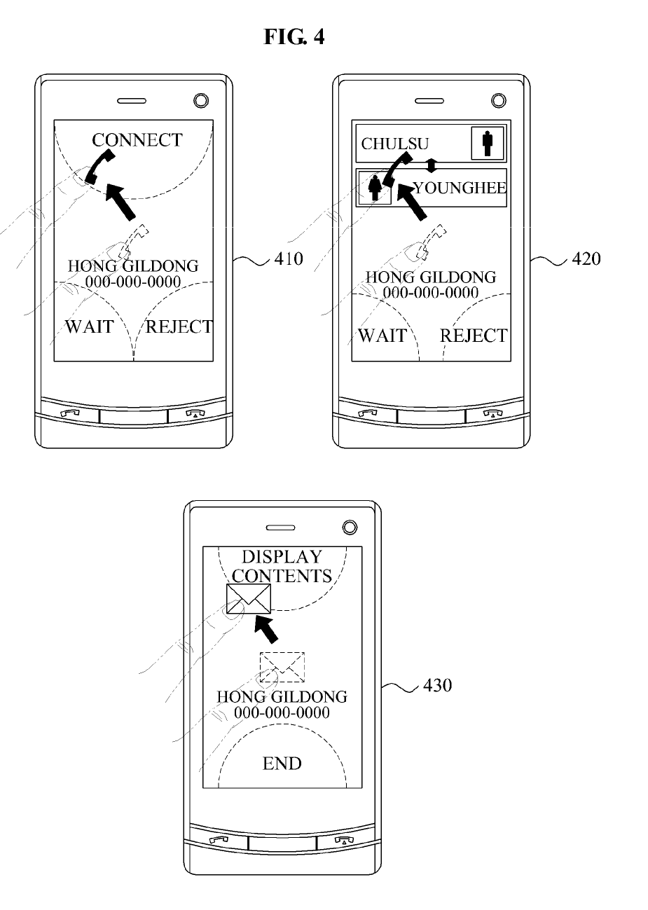

FIG. 4 illustrates an example of performing a function according to a touch input in a handheld terminal according to an exemplary embodiment of the present invention.

If the handheld terminal receives an incoming call or is to make an outgoing call, for example, a service icon may be displayed on the handheld terminal. Additionally, process areas corresponding to the displayed service icon may be displayed on the handheld terminal. The process areas may each correspond to a different function to be performed in response to the incoming call.

If a user touches the service icon, such as a telephone receiver figure associated with a contact and contact's telephone number, in the handheld terminal 410 and drags the touch to a process area where a function of ‘connect’ is displayed before releasing the touch, the function performer 260 may place a call to ‘Hong Gildong’. The coordinate recognizer 220 may recognize the touched service icon as a first coordinate, and the process area where the touch is dropped as a second coordinate. If there is a call from ‘Hong Gildong’, such as shown in handheld terminal 420, a service icon corresponding to the incoming call and process areas corresponding to the service icon are displayed on the screen. Then, the user touches a service icon and drags the touch to one of displayed process areas, such as ‘connect’, ‘wait’, or ‘reject’, and selects the corresponding function, and thus, the function performer 260 may perform the selected function.

If the user touches the service icon and drags and drops the touch at a second coordinate located between an icon where ‘Chulsu’ is displayed and an icon where ‘Younghee’ is displayed in handheld terminal 420, the function performer 260 may call Chulsu and Younghee, or may call neither, according to the function associated with that second coordinate.

Also, if the user touches a service icon, such as a figure of an envelope, and drags the touch to move to a process area where a function of ‘display contents’ is displayed, the function performer 260 may display the contents of a received message.

As shown in FIG. 4, the handheld terminal 410 may have three process areas, namely, ‘connect’, ‘wait’, and ‘reject’ associated with the displayed service icon. However, the handheld terminal 430 has two process areas, namely, ‘display contents’ and ‘end’. Since a number of possible functions may be different depending upon a displayed service icon, the screen controller 250 may change a number of process areas displayed in the touch screen 210 and a size of the process area according to a preprogrammed setting or a setting that may be adjusted, for example, by a user or by adaptive software.

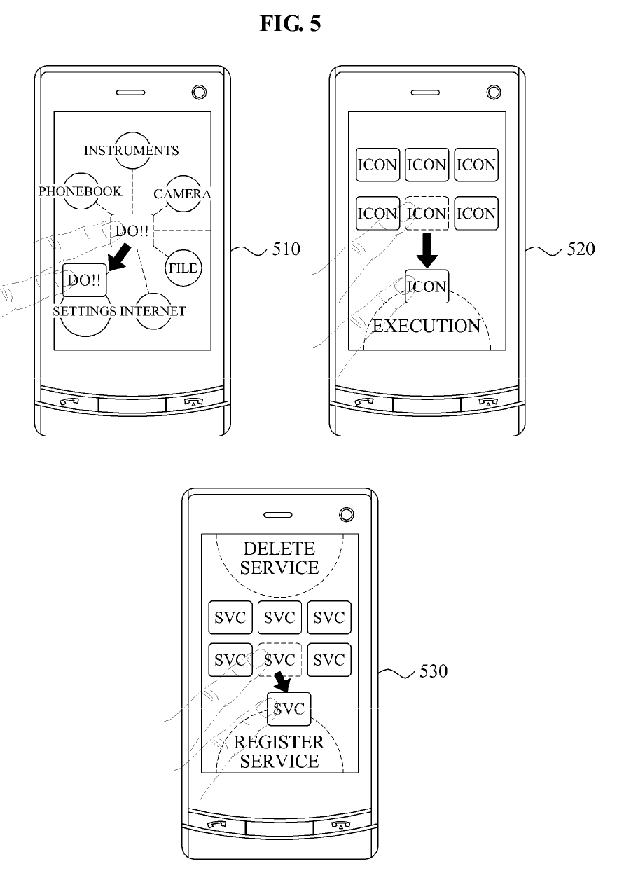

FIG. 5 illustrates an example of performing a function according to a touch input in a handheld terminal according to an exemplary embodiment of the present invention.

As illustrated in handheld terminal 510, the screen controller 250 may control the handheld terminal 510 to display a service icon ‘Do!!’ and a menu provided by the handheld terminal 200, such as a phonebook, instruments, a camera, a file, an Internet connection, and settings, in the touch screen 210. If a user touches the service icon ‘Do!!’, and drags and drops the touch to a process area where a function of ‘settings’ is displayed, the function performer 260 may perform the function of displaying the detailed contents corresponding to the menu of ‘settings’.

Also, the screen controller 250 in a handheld terminal 520 may display many service icons at once on a menu displayed on the touch screen 210. The user may touch a service icon that performs a desired function, and may drag and drop the touch to a process area where a function of ‘execution’ is displayed. Here, the coordinate recognizer 220 recognizes the touched service icon as a first coordinate, and recognizes a second coordinate in the process area related to the ‘execution’. Also, the function performer 260 may perform the function of the service icon that is touched and moved to the process area of the ‘execution’.

Also, the screen controller 250 in a handheld terminal 530 may display many service icons and may display process areas with respect to ‘delete service’ and ‘register service’. Accordingly, the function performer 260 may delete or register a service icon that is touched, and dragged and dropped to a process area.

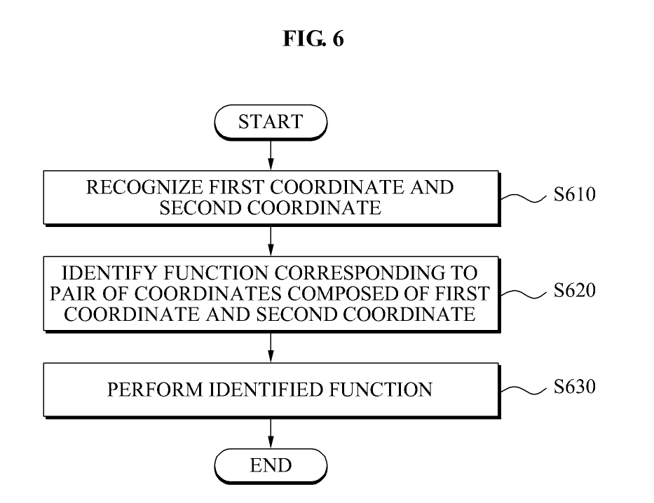

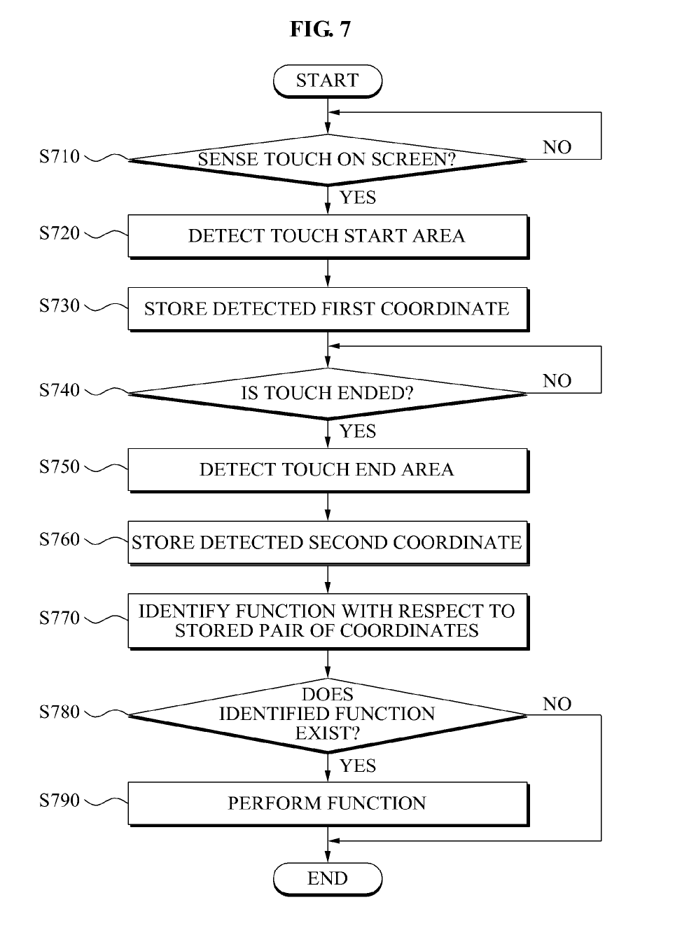

Hereinafter, a method for controlling a handheld terminal using a touch input will be described in more detail. The methods described with reference to FIG. 6 and FIG. 7 will be described with reference to FIG. 2, but this is simply for ease of description and is not required.

FIG. 6 is a flowchart illustrating a method for controlling a handheld terminal using a touch input according to an exemplary embodiment of the present invention

In operation S601, the handheld terminal 200 recognizes a first coordinate on a screen where a touch starts and recognizes a second coordinate on the screen where the touch ends. Between the first coordinate and the second coordinate, the touch may maintain continuous contact with the touch screen 210.

If a user touches the touch screen 210 in a drag-and-drop scheme using the user's hand or an object, and drags the touch at the first coordinate where the touch starts and drops the touch at the second coordinate, the coordinate recognizer 220 may recognize the first coordinate and the second coordinate.

As an example, the first coordinate may be a coordinate in a start coordinate area where a service icon is displayed, and the second coordinate may be a coordinate in a process area where a function is processed.

In operation S620, the handheld terminal 200 identifies a function corresponding to the pair of coordinates including the first coordinate and the second coordinate.

As an example, the handheld terminal 200 may identify the function corresponding to the pair of coordinates from a database 240. The database 240 may store functions corresponding to pairs of coordinates. The pair of coordinates may include a coordinate in the start coordinate area and a coordinate in the end coordinate area. That is, the start coordinate area and the end coordinate area may each include at least one coordinate, and the pair of coordinates may be constructed by matching coordinates from the start coordinate area and the end coordinate area.

Referring to FIG. 3, the function identifier 230 may identify a function of'call connecting' if the pair of coordinates is (A, B1), may identify a function of ‘call waiting’ if the pair of coordinates is (A, B2), may identify a function of ‘call ending’ if the pair of coordinates is (A, B3), and may identify a function of ‘call rejecting’ if the pair of coordinates is (A, B4).

In operation S630, the handheld terminal 200 may perform the identified function. As an example, the function performer 260 may perform the identified function, namely, ‘connect’, ‘wait’, ‘end’, or ‘reject’, corresponding to the recognized pair of coordinates.

FIG. 7 is a flowchart illustrating a method for controlling a handheld terminal using a touch input according to an exemplary embodiment of the present invention.

The handheld terminal 200 senses a touch on the touch screen 210 in operation S710, detects a start area where the touch starts in operation S720, and stores a first coordinate corresponding to the detected start area from the database 240 in operation S730. Also, the handheld terminal 200 senses whether the touch ends in operation S740, and if so, detects an end area where the touch ends in operation S750, and stores a second coordinate of the detected end area in operation S760. As described above, the database 240 may store functions respectively corresponding to pairs of coordinates including the first coordinate and the second coordinate.

Then, the handheld terminal 200 identifies, from the database 240, whether a function corresponding to the pair of coordinates exists in operation S770, and performs the corresponding function in operation S790 if the corresponding function exists in operation S780. However, if a corresponding function is not identified from the database 240, the handheld terminal 200 may not perform any function.

The method according to the above-described exemplary embodiments may be recorded in computer-readable media including program instructions to implement various operations embodied by a computer when executed. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

According to the exemplary embodiments, a handheld terminal recognizes a first coordinate where a touch starts and recognizes a second coordinate where the touch ends, identifies a function corresponding to a pair of coordinates including the first coordinate and the second coordinate, and performs the identified function.

Also, according to the exemplary embodiments, if a user drags a service icon having a first coordinate and moves the service icon to a second coordinate in a process area where the service icon is dropped, the a handheld terminal may perform a function corresponding to a pair of coordinates having the first coordinate and the second coordinate.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A handheld terminal, comprising:
a touch screen to receive a touch and to display a service icon, a first process area, and a second process area, the first process area corresponding to a first function associated with the service icon and the second process area corresponding to a second function associated with the service icon;
a coordinate recognizer to recognize a first coordinate where the touch starts and to recognize a second coordinate where the touch ends;
a function identifier to identify the first function or the second function as an identified function corresponding to a pair of coordinates comprising the first coordinate and the second coordinate; and
a function performer to perform the identified function.

2. The handheld terminal of claim 1, wherein the first coordinate is related to the service icon, and the function identifier identifies the function based on the pair of coordinates and the service icon.

3. The handheld terminal of claim 1, wherein the second coordinate is related to the first process area or the second process area, and the function identifier identifies the first function or the second function as the identified function, respectively.

4. The handheld terminal of claim 1, wherein the function identifier identifies, from a database, the identified function corresponding to the pair of coordinates.

5. The handheld terminal of claim 4, wherein the database stores functions respectively corresponding to pairs of coordinates.

6. The handheld terminal of claim 1, wherein the first coordinate is related to the service icon, and the coordinate identifier identifies the second coordinate within the first process area or the second process area according to where the touch ends.

7. The handheld terminal of claim 6, wherein the function identifier identifies the identified function based on the service icon and the first process area or the second process area according to where the touch ends.

8. The handheld terminal of claim 6, wherein the coordinate identifier recognizes the first coordinate within a start coordinate area where the service icon is displayed.

9. A method for controlling a handheld terminal, comprising:
displaying a service icon, a first process area, and a second process area, the first process area corresponding to a first function associated with the service icon and the second process area corresponding to a second function associated with the service icon;
receiving a touch on a touch screen;
recognizing a first coordinate where the touch starts and a second coordinate where the touch ends;
identifying the first function or the second function as an identified function corresponding to a pair of coordinates comprising the first coordinate and the second coordinate; and
performing the identified function.

10. The method of claim 9, wherein the first coordinate is related to the service icon, and the identified function is identified based on the pair of coordinates and the service icon.

11. The method of claim 9, wherein the second coordinate is related to the first process area or the second process area, and the identified function is identified as the first function or the second function, respectively.

12. The method of claim 9, wherein identifying the identified function comprises identifying, from a database, the identified function corresponding to the pair of coordinates.

13. The method of claim 12, further comprising:
storing functions respectively corresponding to pairs of coordinates.

14. The method of claim 9, wherein the first coordinate is related to the service icon, and identifying the identified function comprises identifying the second coordinate within the first process area or the second process area according to where the touch ends.

15. The method of claim 14, wherein identifying the indentified function comprises identifying the identified function based on the service icon and the first process area or the second process area according to where the touch ends.

16. The method of claim 14, wherein identifying the identified function comprises:
identifying the first coordinate within a coordinate start area where the service icon is displayed.

17. A computer comprising a processor and a computer readable recording media storing a program, and the program, when executed, performs the method of claim 9.
